(19) United States
(12) Patent Application Publication
(10) Pub. No.: US 2008/0151834 A1
(43) Pub. Date: Jun. 26, 2008

(54) METHOD AND APPARATUS FOR MAINTAINING TRAFFIC FLOW IN A MESH NETWORK

(75) Inventor: Kadathur S. Natarajan, Wilmette, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/613,486

(22) Filed: Dec. 20, 2006

(51) Int. Cl. H04Q 7/00

(52) U.S. Cl. 370/331

(57) ABSTRACT

A system dynamically adjusts bandwidth allocations in a mesh network that includes at least two data communication pathways (214 and 222, 216, and 212) between a first access point (AP1) and a second access point (AP2). The first access point (AP1) determines an amount of data to be sent to the second access point (AP2) and selects at least one of the data communication pathways (214 and 222, 216, and 212) for sending the amount of data. The first access point (AP1) receives an overload value indicating a maximum amount of data to be transmitted to the second access point (AP2) along the selected data communication pathway, compares the overload value to the amount of data to be sent, and reduces a routing probability value assigned to the selected communication pathway in response to the overload value being less than the amount of data to be sent.

### FIELD OF THE INVENTION

This invention relates in general to communication systems, and more specifically to a system, method, and apparatus for dynamically adjusting data traffic volume within a wireless mesh communications network.

### BACKGROUND OF THE INVENTION

Standard Wi-Fi and cellular networks follow a hub and-spoke model. The hub and spoke model suffers from many shortcomings including relaying all the traffic back to the central hub, large backhaul bandwidths, scalability issues as more and more users join the network, and its vulnerability to a single point of failure. Mesh network technology uses a peer to peer connection model, which is much more efficient and addresses many of the problems related to the hub-and-spoke model.

A mesh network is a network in which the nodes are interconnected with one or more other nodes in the network and functions as a multi-hop network in which the data traverses multiple hops before reaching an internet gateway or an access point. The network can be connected with wires or can be a wireless mesh network (WMN) in which the nodes are connected to each other wirelessly. The multi-hop capability provides users with ubiquitous communicating capability and information access regardless of their location. In many practical operations, e.g., battlefield communication, multi-hop ad hoc mobile wireless networks provide the only feasible means for ground communications and information access. Ideally, a mesh network is a dynamically self-organizing, self-configuring, and self healing network.

FIG. 1 shows an example of a WMN 100. As can be seen in FIG. 1, a plurality of access points AP1-AP6 are deployed and operate in a peer-to-peer fashion to establish links, where possible, and as required, among each access point's neighbors. For example access point AP3 can establish links or data communication pathways 102, 104, and 106 with, respectively, access points AP6, AP2, and AP4. Through the established paths, each access point AP1-AP6 is able to route traffic to and from a core network 112 and provide shared access to subscribers for both uplink and downlink communications. Therefore, each access point is able to act as a data source, such as when it is receiving information directly from subscriber devices. In addition, each access point AP1-AP6 is able to act as a conduit and relay information signals from an originating access point to a target access point or to the core network 112 when any of the access points are not able to create a direct communication link or path from one to the other point. Information that is being communicated may be relayed or handed from access point to access point until it reaches the intended destination or target access point. For example, if access point AP4 wanted to communicate with access point AP2 or the core network 112, information from access point AP4 would be relayed by access point AP6 to access point AP2 or on to the core network 112. However, if the direct link 114 from access point AP4 to AP6 was interrupted or blocked, the inherent redundancy in the mesh architecture allows routing the information from access point AP4 through access point AP3 to access point AP2 or through access point AP5, to access point AP1, and on to access point AP2.

However, the mesh architecture or system can experience problems as the intensity of the communication traffic increases. For instance, Table 1 shows a portion of an exemplary routing table for access point AP3 in the WMN 100 shown in FIG. 1. The table is generally stored in memory and referenced by the access point to make routing decisions.

TABLE 1
Routing Table (partial) at AP3

| Destination | Next Access Point | Percentage of Traffic |
|---|---|---|
| AP2 | AP2 | 100% |
| AP5 | AP4 | 50% |
| AP5 | AP6 | 50% |

The first column of Table 1 is the destination access point for traffic originated from access point AP3, which also includes traffic flowing from some other access point through access point AP3. The destination access point is not necessarily the final destination of traffic being sent from AP3, but is at least a temporary destination, regardless of the path it takes within the WMN 100. After the data reaches the destination, it is typically forwarded on to the core network through some configurable path.

The second column in Table 1 is the next access point, which specifies at least the next immediate node in the path taken to reach the destination specified in column 1. In larger networks, Table 1 would be expanded to include many additional rows to identify various path choices to various destinations in the mesh data network.

The third column identifies the percentage of access point AP3's traffic that access point AP3 will send to the next access point, specified in column two. Specifically, looking at Table 1, for the final destination AP2, access point AP3 sends its traffic directly to access point AP2 100% of the time without utilizing any other access points as conduits. However, if AP3 sends data to access point AP5 as a final destination, AP3 has three choices for the next node—AP4, AP6 and AP2. In Table 1, AP3 has chosen AP4 and AP6 with equal probability while AP2 is excluded. On receipt of a data packet, AP3 will transmit the packet to AP4 or AP6 with equal probability (e.g., generate a random number between 0 and 1 and, if less than 0.5, send to AP4, otherwise, send to AP6),

In addition to its own generated traffic, such as calls handled for subscribers in the access point's service area, each access point AP1-AP6, as explained above, is able to receive data traffic from other access points in the network. For instance, Table 2 below shows an exemplary routing table for access point AP4 in the WMN 100 shown in FIG. 2.

TABLE 2
Routing Table at AP4 (partial routing table)

| Destination | Next Access Point | Percentage of Traffic |
|---|---|---|
| AP5 | AP5 | 100% |
| AP2 | AP3 | 30% |
| AP2 | AP6 | 70% |

Access point AP4 routes traffic to access point AP2 through access points AP3 and AP6. Therefore, access point AP3 not only generates its own traffic, it also receives from and forwards traffic to other access points. Other access points in the WMN 100 may also forward data through access point AP3.

However, each communication pathway from an access point to its neighbor access point has a traffic handling capacity, above which, it is not able to effectively handle more data. Therefore, exceeding a specified bandwidth, such as when a pathway is broken and multiple access points channel their traffic along a single communication pathway from an access point, causes system performance to be degraded and data to be lost or delayed. Conversely, limiting data flow unnecessarily restricts system performance and reduces achievable throughput (or, the revenue generating opportunity for operators deploying the mesh network).

Therefore, a need exists to overcome the problems with the prior art as discussed above.

### SUMMARY OF THE INVENTION

A method and system are disclosed for dynamically adjusting bandwidth allocations in a wireless communication system that provide at least two data communication pathways between a first access point and a second access point. According to an embodiment of the present invention, the method includes determining an amount of data to be sent from the first access point to the second access point, selecting at least one of the at least two data communication pathways for sending the amount of data, receiving an overload value indicating a maximum amount of data to be transmitted to the second access point along the selected data communication pathway, comparing the overload value to the amount of data to be sent, and then reducing a routing probability value assigned to the selected communication pathway in response to the overload value being less than the amount of data to be sent.

According to an embodiment of the present invention, the system includes a first access point in a wireless communication system providing at least two data communication pathways for communicating data between the first access point and a second access point, where the first access point includes a data counter for determining an amount of data to be sent to the second access point, a selector for selecting which of the at least two data communication pathways is to be used for communicating the amount of data from the first access point to the second access point, an input for receiving an overload value indicating a maximum amount of data to be transmitted from the first access point to the second access point along the selected data communication pathway, a comparator for comparing the overload value to the amount of data to be sent, and a processor for reducing a routing probability value assigned to the selected communication pathway in response to the overload value being less than the amount of data to be sent.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating an exemplary mesh network communications system, according to an embodiment of the present invention;

FIG. 2 is a block diagram illustrating a communication system that includes the mesh network of FIG. 1 in wireless communication with subscriber devices, according to an embodiment of the present invention;

FIG. 3 is a block diagram illustrating an exemplary access point, according to an embodiment of the present invention;

FIG. 4 illustrates a frame structure for time division duplex communications according to an embodiment of the present invention; and

FIG. 5 is a flow diagram of the bandwidth distribution process according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smart phone, a two-way radio, a two-way pager, a wireless messaging device, a laptop/computer, automotive gateway, residential gateway, and the like.

Exemplary Wireless Communications System

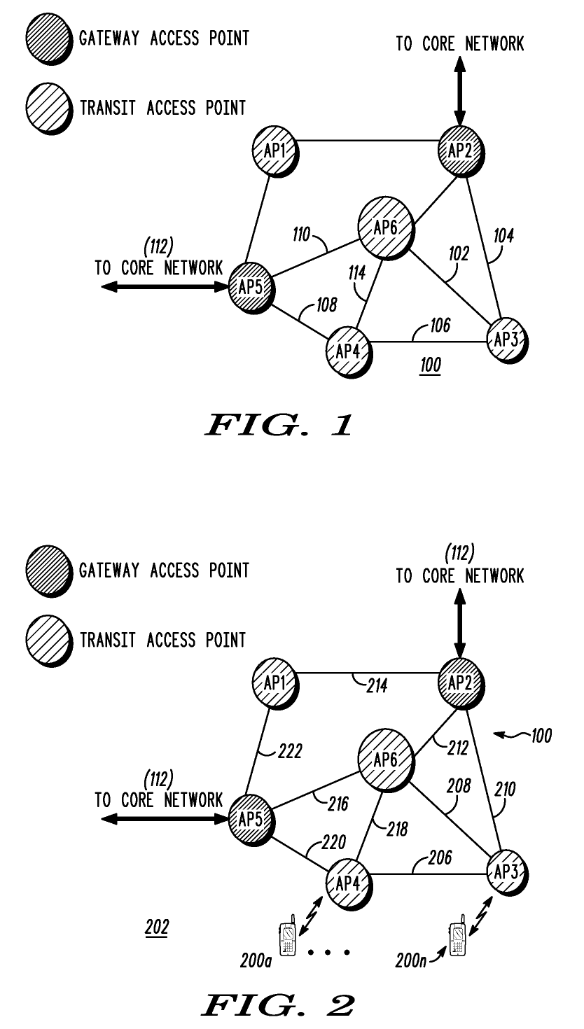

According to an embodiment of the present invention, as shown in FIG. 2, exemplary wireless communication devices 200a-n are illustrated communicatively coupled to a WMN 100. The WMN 100 connects wireless communication devices 200a-n to a core network 112. The WMN 100 comprises a mobile phone network, a mobile text messaging device network, a pager network, or the like. Furthermore, the communications standard of the WMN 100 of FIGS. 1 and 2 comprises Code Division Multiple Access (CDMA), Time Division Multiple Access (TDMA), Global System for Mobile Communications (GSM), General Packet Radio Service (GPRS), Frequency Division Multiple Access (FDMA), Orthogonal Frequency Division Multiplexing (OFDM), or the like. Additionally, the WMN 100 comprises text messaging standards, for example, Short Message Service (SMS), Enhanced Messaging Service (EMS), Multimedia Messaging Service (MMS), or the like and allows for push-to-talk over cellular communications between capable wireless communication devices.

The WMN 100 supports any number of wireless communication devices 200a-n. The support of the WMN 100 includes support for mobile telephones, smart phones, text messaging devices, handheld computers, pagers, beepers, or the like. In one embodiment, WMN 100 allows for mesh networking between two or more wireless communication devices 200a-n.

In an exemplary embodiment, the WMN 100, the core network 112, and the wireless communication devices 200a-n together comprise a wireless communication system 202. The WMN 100 of the wireless communication system 202 is capable of any broadband wireless communications technology, for example, time division duplexing (“TDD”) using the 802.16e standard. Other standards can also be used and the wireless communications system 202 is not limited to using only the TDD scheme. For example, TDD may be used for a portion of the available communication channels in the communication system, while one or more schemes are used for the remaining communication channels. However, TDD is advantageous in that it is flexible with regard to allocation of timeslots for forward and reverse, making it well suited for asymmetrical applications.

Access Points

The WMN 100 includes a group of base stations, or “access points” AP1-AP6 that each has a dedicated connection to one or more other access points AP1-AP6. Each access point AP1-AP6 provides shared access to subscriber devices 200a-n (both Uplink, i.e., from the devices 200a-n to the core network 112, and Downlink, i.e., from the core network 112 to the devices 200a-n). The access points AP1-AP6 are connected in a mesh network topology to route the traffic to/from the core network 112. A “Gateway” access point AP5, AP2 is an access point that serves dual purposes: 1. the standard function of providing access to subscribers it covers; and 2. to serve as ingress and egress points to the core network 112. A “Transit” access point AP1, AP3, AP4, AP6 is an access point that: 1. provides access service to subscribers in its coverage area; and 2. serves as a transit node for forwarding traffic to subscribers that are served by other access points.

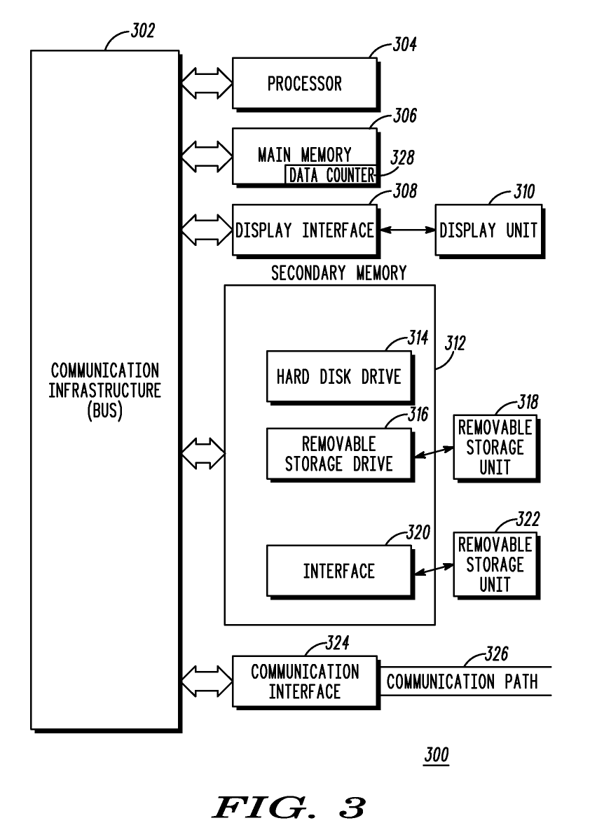

FIG. 3 is a high level block diagram illustrating a more detailed view of a processing and communication system utilized with the access points AP1-AP6 according to embodiments of the present invention. FIG. 3 shows an information processing system 300 useful for implementing one of the access points AP1-AP6. The system 300, in one embodiment, resides outside of and is communicatively coupled to its respective access point. In another embodiment, the system 300 resides within its respective access point. The information processing system 300 is based upon a suitably configured processing system adapted to implement the exemplary embodiment of the present invention. For example, a personal computer, workstation, or the like, may be used.

In one embodiment of the present invention, the computer system 300 includes one or more processors, such as processor 304. The processor 304 is connected to a communication infrastructure 302 (e.g., a communications bus, crossover bar, or network). Various software embodiments are described in terms of this exemplary computer system. After reading this description, it will become apparent to a person of ordinary skill in the relevant art(s) how to implement the invention using other computer systems and/or computer architectures.

The computer system 300 can include a display interface 308 that forwards graphics, text, and other data from the communication infrastructure 302 (or from a frame buffer) for display on the display unit 310. The computer system also includes a main memory 306, preferably random access memory (RAM), and may also include a secondary memory 312. The processor 304 in conjunction with the memory 306, 312 and/or the communication interface 324 performs as a data counter 328 for determining an amount of data to be sent from one access point to another. The secondary memory 312 may include, for example, a hard disk drive 314 and/or a removable storage drive 316, representing a floppy disk drive, a magnetic tape drive, an optical disk drive, etc. The removable storage drive 316 reads from and/or writes to a removable storage unit 318 in a manner well known to those having ordinary skill in the art. Removable storage unit 318, represents a floppy disk, a compact disc, magnetic tape, optical disk, etc. which is read by and written to by removable storage drive 316. As will be appreciated, the removable storage unit 318 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 312 may include other similar means for allowing computer programs or other instructions to be loaded into the computer system. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to the computer system.

The computer system, in this example, includes a communications interface 324 that acts as an input and output and allows software and data to be transferred between the computer system and external devices or access points via a communications path 326. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. The signals are provided to communications interface 324 via a communications path (i.e., channel) 326. The channel 326 carries signals and may be implemented using wire or cable, fiber optics, a phone line, a cellular phone link, an RF link, and/or other communications channels. Data stored in any of the data storage areas 306, 312 of the computer system 300 can be inventoried. Therefore, the computer system 300 provides a data counter 328 that can determine the amount of data that has arrived at the access point via communication interface 324. The communication interface 324 also acts as an input for receiving information from other access points, such as values indicating amounts of data that are scheduled to be received from the other access points and as an output for sending data to the other access points.

In this document, the terms “computer program medium,” “computer usable medium,” and “computer readable medium” are used to generally refer to media such as main memory 306 and secondary memory 312, removable storage drive 316, a hard disk installed in hard disk drive 314, and signals. The computer program products are means for providing software to the computer system. The computer readable medium allows the computer system to read data, instructions, messages or message packets, and other computer readable information from the computer readable medium.

Computer programs (also called computer control logic) are stored in main memory 306 and/or secondary memory 312. Computer programs may also be received via communications interface 324. Such computer programs, when executed, enable the computer system to perform the features of the present invention as discussed herein. In particular, the computer programs, when executed, enable the processor 304 to perform the features of the computer system. For instance, by utilizing computer programs, the processor 304 can act as a selector for selecting which of several available communication pathways should be used to communicate between one access point to another. In addition, the processor 304 is able to compare two values to make determinations, such as whether or not a particular communication path is loaded in excess of an overload limit. Accordingly, such computer programs represent controllers of the computer system.

Mesh Routes

Routes 206-222, shown in FIG. 2, are dedicated communication channels for transporting traffic between each Transit access point and every other access point (Gateway access point as well as Transit access point). The routes can be wired or wireless and can include any medium for transferring data from a first point to a second point. Each access point stores in its memory a table, such as Table 1 above, of possible routes. This table can be referenced by the access point to allow it to make determinations of routes and route alternatives. The number of access points and corresponding routes shown in the figures is merely exemplary. The present invention is not limited to any particular number of access points or routes.

Backhauling

Manufacturers of network switching equipment use the term “backhauling” to mean “getting data to the network backbone” or core network 112. For example, looking again at FIG. 2, the term can be used to describe how an access point AP1-AP6 can be used to interconnect data from a remote user 200 to an Internet service provider and the core network 112.

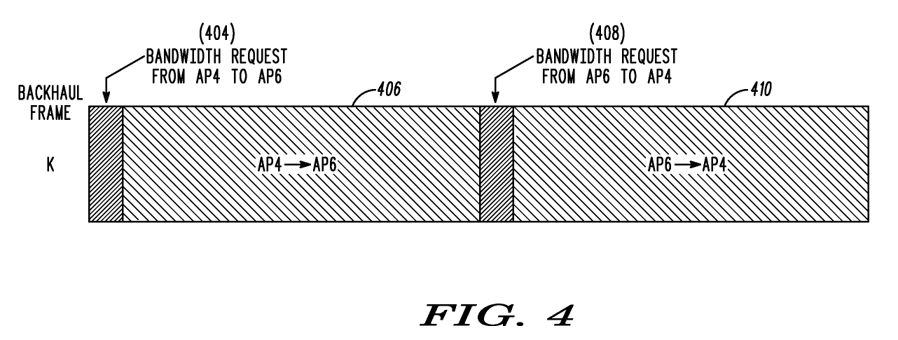

FIG. 4 shows a backhaul frame K for routing data from a first access point AP4 to and from a second access point AP6. The backhaul frame K is divided into four portions. The first portion 404 and the third portion 408 are bandwidth requests and will be discussed in detail below. The second portion 406 is information sent from the first access point AP4 to the second access point AP6 and the fourth portion 410 is information sent from the second access point AP6 back to the first access point AP4. The particular first and second access points used here are merely exemplary and the present invention is not limited to any particular first and second access point.

While in operation, the quantity of data traffic being routed between any two access points within the WMN 100 changes from moment to moment. In embodiments of the present invention, each access point AP1-AP6, through use of communication interface 324, processor 304, or other means, is able to access the amount of data it has to transmit along each path. Additionally, each access point AP1-AP6 is able to receive and interpret messages, through use of communication interface 324, processor 304, or other means, from other access points indicating an amount of data that those other access points AP1-AP6 have to transmit to that access point. In embodiments of the present invention, this bandwidth information is stored at each access point and communicated in the first 404 and third portions 408 of each backhaul frame K.

Therefore, the first portion 404 of the backhaul frame K is a bandwidth request message identifying the amount of traffic to be transported from AP4 to a neighboring access point AP6. Bandwidth requests are utilized to compute how much traffic needs to be sent from one node to a neighbor node and what fraction of the backhaul bandwidth should be used in each direction of the subsequent backhaul frame, identified as X+1 where X is the current frame. Backhaul traffic is determined at the beginning of each backhaul frame based on a number of factors. Exemplary factors may include the amount of uplink traffic to be transported to a destination access point, the routes defined in the routing tables at the access point to reach the destination access points, the amount of downlink traffic from various access points toward subscribers, the routes defined at each access point to reach other access points.

In accordance with embodiments of the present invention, at the beginning of each backhaul frame, by utilizing traffic information contained in previously received backhaul frames, each access point is able to adjust the percentage of traffic flowing to its adjacent access points, provided there is more than one way to route the data from a source access point to a destination access point. Specifically, when the utilization of a link AP I→AP J exceeds a threshold β1 (a configurable parameter), the traffic routed on that link is reduced by α1%, which can be any percentage from 0-100. Similarly, when the utilization of a link AP I→AP J falls below a threshold β2 (another configurable parameter), the traffic routed on that link is increased by α2%, which can be any percentage from 0-100.

The traffic increasing and decreasing steps are executed at each access point by monitoring the congestion state of links and revising the routing probability up and down depending on the link congestion.

The traffic is routed to favor less congested paths in the mesh network leading to an expected reduction in end-to-end delay through the mesh network and an improvement in end-to-end quality of service through the network.

The dynamic traffic adjustment process of the present invention can be executed at each access point autonomously utilizing backhaul bandwidth request messages received from the neighboring access points in the mesh network. The Routing Tables used may be changed dynamically based on load conditions or link status changes (such as failures) and the traffic assignment will adjust automatically to the new settings.

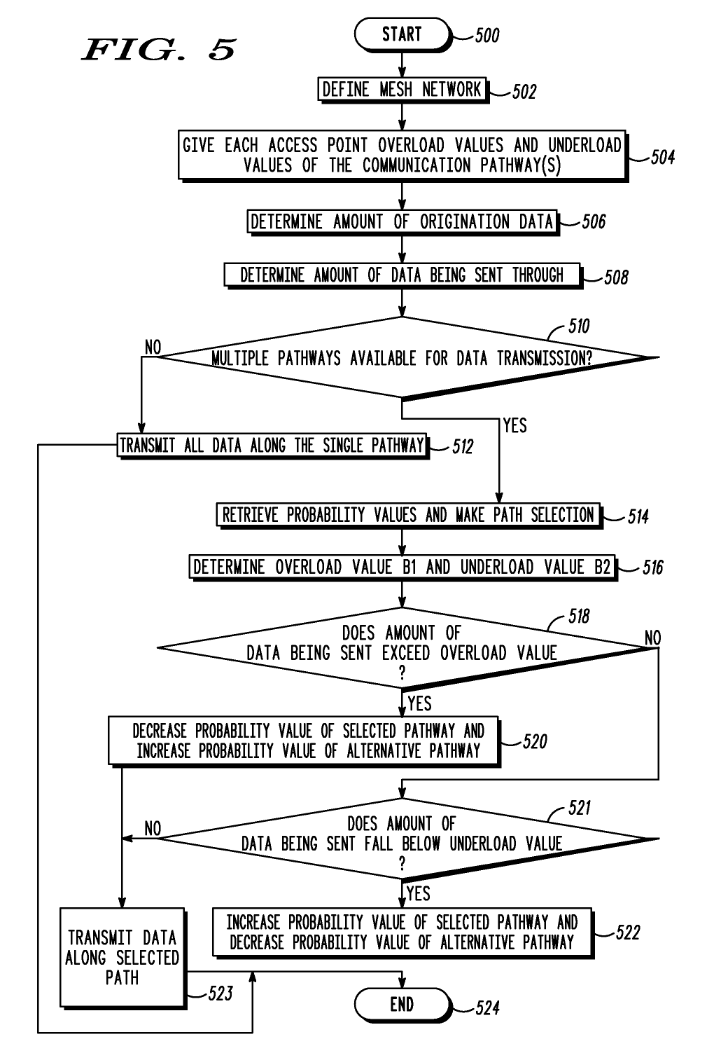

FIG. 5 illustrates the process flow of the present invention. The process begins at step 500 and flows directly to step 502 where a mesh network, such as network 100, is defined. The definition of the network includes minimum and maximum bandwidth limitations on data communication pathways between access points. The maximum bandwidth limitations are defined in overload values stored in memory and work to prevent data loss by preventing network traffic from exceeding network equipment data-handling capabilities. The minimum limits are values that help ensure a particular link does not become unnecessarily underutilized. The minimum limits are defined in underload values stored in memory. In step 504, each access point is given the minimum and maximum bandwidth limitations of the communication pathway(s) to which it is connected.

In step 506, a first access point determines the amount of data that it originated into the network and has to send to a second node. In step 508, the first access point determines the amount of data that it is being requested to send through it as a conduit to the second node. Next, in step 510, the first access point references a table, such as Table 1, to determine which pathway(s) is available for transmitting the data to its destination. For instance, looking at Table 1 in conjunction with FIG. 1, it can be seen that access point AP3 can send data to access point AP5 by utilizing two different data communication pathways. The first pathway is from access point AP3, along communication pathway 102 to access point AP6, and along communication pathway 110 to access point AP5. The second pathway is along communication pathway 106, to access point AP4, and along communication pathway 108 to access point AP5.

If only one pathway is available, the first access point, in step 512, transmits all of the data along the single pathway to the destination access point and the process ends at step 524. However, if there is more than one pathway to choose from, the first access point, in step 514, looks in the table to retrieve the probability values for sending data along each of the available paths and makes a path selection based on the retrieved probability numbers. For instance, referring again to Table 1 above, it can be seen that AP5 can be reached by going through either AP4 or AP6 and each are equally probably candidates. Therefore, the access point will select a path by any means, such as generating a random number between 0 and 1 and, if less than 0.5, sending the data through AP4, otherwise, sending it through AP6).

The first access point, in step 516, then searches an area of memory to find a maximum β1 (a configurable parameter) and a minimum data traffic threshold value β2 (a configurable parameter) for that pathway. In step 518, the first access point compares the amount of data to be sent to the maximum threshold value. If the amount of data to be sent along the selected path exceeds the maximum threshold value β1, the percentage of traffic value in the table is decreased by an amount α1% and the alternative pathway in the chart is increased by that same amount in step 520. The data is transmitted in step 523 and the process ends at step 524. If, at step 518, the amount of data to be sent along the selected path does not exceed the maximum threshold value, a comparison is made at step 521 to determine if the amount of data to be sent along the selected path is below the threshold β2. If the answer is no, the data is transmitted in step 523 and the process ends at step 524. However, if the answer to step 521 is yes, the percentage of traffic value in the chart that defines the amount of traffic routed on that link is increased by α2% and the alternative pathway in the chart is decreased by that same amount in step 522. The data is transmitted in step 523 and the process ends at step 524.

The foregoing embodiments of the present invention are advantageous because they provide dynamic optimization of the resources available to wireless communication devices. Information can be more efficiently communicated between subscriber devices and a core network by optimizing bandwidth distribution along each direction between access points. It should be noted that the methods for maintaining traffic flow in a mesh network per the present invention will work with any technology (including Advanced Antenna schemes for Point to Point wireless communication).

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for dynamically adjusting bandwidth allocations in a wireless communication system providing at least two data communication pathways between a first access point and a second access point, the method comprising:
determining an amount of data to be sent from the first access point to the second access point;
selecting at least one of the at least two data communication pathways for sending the amount of data;
receiving an overload value indicating a maximum amount of data to be transmitted to the second access point along the selected data communication pathway;
comparing the overload value to the amount of data to be sent; and
reducing a routing probability value assigned to the selected communication pathway in response to the overload value being less than the amount of data to be sent.

2. The method according to claim 1, wherein the selecting is performed by using at least one of:
the routing probability value assigned to the selected communication pathway; and
a routing probability value assigned to at least a second of the at least two data communication pathways.

3. The method according to claim 2, further comprising:
increasing the routing probability value assigned to the at least a second of the at least two data communication pathways in response to the overload value being less than the amount of data to be sent.

4. The method according to claim 1, further comprising:
receiving an underload value indicating a minimum amount of data to be transmitted to the second access point along the selected data communication pathway;
comparing the underload value to the amount of data to be sent; and
increasing a routing probability value assigned to the selected communication pathway in response to the overload value being greater than the amount of data to be sent.

5. The method according to claim 4, further comprising:
decreasing a routing probability value assigned to a second of the at least two data communication pathways in response to the underload value being greater than the amount of data to be sent.

6. The method according to claim 1, further comprising, before selecting at least one of the at least two data communication pathways for sending the amount of data:
assigning a first routing probability value to a first of the at least two data communication pathways; and
assigning a second routing probability value to a second of the at least two data communication pathways.

7. The method according to claim 6, wherein:
the routing probability value used to select the at least one of the at least two data communication pathways is one of the first routing probability value and the second routing probability value.

8. A first access point in a wireless communication system providing at least two data communication pathways for communicating data between the first access point and a second access point, the first access point comprising:
a data counter for determining an amount of data to be sent to the second access point; and
a processor configured to:
select which of the at least two data communication pathways is to be used for communicating the amount of data from the first access point to the second access point;
receive an overload value indicating a maximum amount of data to be transmitted from the first access point to the second access point along the selected data communication pathway;
compare the overload value to the amount of data to be sent; and
reduce a routing probability value assigned to the selected communication pathway in response to the overload value being less than the amount of data to be sent.

9. The first access point according to claim 8, wherein the processor is further configured to select by using at least one of:
a routing probability value assigned to the selected communication pathway; and
a routing probability value assigned to at least a second of the at least two data communication pathways.

10. The first access point according to claim 9, wherein the processor increases the routing probability value assigned to the at least a second of the at least two data communication pathways in response to the overload value being less than the amount of data to be sent.

11. The first access point according to claim 8, wherein the processor is further configured to:
receive an underload value indicating a minimum amount of data to be transmitted to the second access point along the selected data communication pathway;
compare the underload value to the amount of data to be sent; and
increase a routing probability value assigned to the selected communication pathway in response to the overload value being greater than the amount of data to be sent.

12. The first access point according to claim 11, wherein:
the processor decreases a routing probability value assigned to a second of the at least two data communication pathways in response to the underload value being greater than the amount of data to be sent.

13. A computer program product for dynamically adjusting bandwidth allocations in a wireless communication system providing at least two data communication pathways between a first access point and a second access point, the computer program product comprising:
a storage medium readable by a processing circuit and storing instructions for execution by the processing circuit for performing a method comprising:
determining an amount of data to be sent from the first access point to the second access point;
selecting at least one of the at least two data communication pathways for sending the amount of data;
receiving an overload value indicating a maximum amount of data to be transmitted to the second access point along the selected data communication pathway;
comparing the overload value to the amount of data to be sent; and
reducing a routing probability value assigned to the selected communication pathway in response to the overload value being less than the amount of data to be sent.

14. The computer program product according to claim 13, wherein the selecting is performed by using at least one of:
the routing probability value assigned to the selected communication pathway; and
a routing probability value assigned to at least a second of the at least two data communication pathways.

15. The computer program product according to claim 14, further comprising:
increasing the routing probability value assigned to the at least a second of the at least two data communication pathways in response to the overload value being less than the amount of data to be sent.

16. The computer program product according to claim 13, further comprising:
receiving an underload value indicating a minimum amount of data to be transmitted to the second access point along the selected data communication pathway;
comparing the underload value to the amount of data to be sent; and
increasing a routing probability value assigned to the selected communication pathway in response to the overload value being greater than the amount of data to be sent.

17. The computer program product according to claim 16, further comprising:
decreasing a routing probability value assigned to a second of the at least two data communication pathways in response to the underload value being greater than the amount of data to be sent.

18. The computer program product according to claim 13, further comprising, before selecting at least one of the at least two data communication pathways for sending the amount of data:
assigning a first routing probability value to a first of the at least two data communication pathways; and
assigning a second routing probability value to a second of the at least two data communication pathways.

19. The computer program product according to claim 18, wherein:
the routing probability value used to select the at least one of the at least two data communication pathways is one of the first routing probability value and the second routing probability value.
